(19) United States
(12) Patent Application Publication
(10) Pub. No.: US 2002/0006495 A1
(43) Pub. Date: Jan. 17, 2002

(54) FLOOR COVERING ARTICLE HAVING A PILE SURFACE AND A VISIBLE DECORATIVE FABRIC BACKING

(76) Inventor: YASHAVANT VINAYAK VINOD, HOCKESSIN, DE (US)

Correspondence Address: GEORGE M MEDWICK, E I DU PONT DE NEMOURS AND COMPANY, LEGAL PATENTS, WILMINGTON, DE, 19898

(21) Appl. No.: 09/074,881

(22) Filed: May 8, 1998

(51) Int. Cl. B32B 3/02; B32B 33/00; D05C 17/00

(52) U.S. Cl. 428/89; 428/92; 428/94; 428/93; 428/86

(57) ABSTRACT

A floor covering article comprises a decorative fabric layer, pile yarns forming a decorative pile surface projecting from and partially covering the upper surface of the decorative fabric layer, and means for securing the pile yarns to the decorative fabric layer. The decorative pile surface covers between about 5% to about 95% of the upper surface of the decorative fabric layer so that the decorative fabric is clearly visible when the floor covering article is in planar orientation. The overall effect of the floor covering article, including the decorative fabric and the decorative pile surface, is decorative.

### FIELD OF THE INVENTION

This invention relates to a floor covering article characterized by the use of a decorative fabric layer and a decorative pile yarn surface.

### BACKGROUND OF THE INVENTION

In the current floor covering market there is generally increasing demand for decorative and stylized floor covering articles. For instance, consumers are seeking new ways to incorporate decorative design and pattern into area rugs. Attempts to accomplish this until now have included increasing the number of colors present in multicolor rugs and carpet, and using different dyeing and printing methods to create various patterns. Different textures are also introduced by varying the yarn pile height, by cut and loop pile tufting and by choosing different yarn linear densities to create berber style effect.

In all of these known floor covering articles having a pile surface, the pile surface covers the entire surface of the supporting backing and is the sole decorative surface of the rug or carpet. It would be desirable to provide a floor covering article having decorative aspects in addition to the pile yarn surface.

### SUMMARY OF THE INVENTION

This invention provides a floor covering article comprising a decorative fabric layer, pile yarns forming a decorative pile surface projecting from and partially covering the upper surface of the fabric, and means for securing the pile yarns to the decorative fabric layer. The decorative fabric layer comprises a fabric having an upper and lower surface, wherein the upper surface is decorative. The decorative pile surface partially covers the upper surface of the fabric so that a portion of the decorative fabric is clearly visible when the floor covering article is in planar orientation. The overall effect of the floor covering article, including the decorative fabric and the decorative pile surface, is decorative. The means for securing the pile yarns in the decorative fabric layer may include a coating of latex, thermoplastic or hot melt adhesive on the lower surface of the decorative fabric, or ultrasonically bonding the pile yarns to the decorative fabric layer. The decorative fabric may be selected from the group consisting of tufted fabric, velour fabric, felt, woven fabric, non-woven fabric, knitted fabric, flocked fabric, stitchbonded fabric, needlepunched fabric and fusion-bonded fabric.

In another aspect, the invention is directed to a process for making a floor covering article comprising forming a pile yarn surface on a decorative fabric. The method for forming a pile yarn surface may include tufting, needlepunching, ultrasonic bonding, fusion-bonding or stitchbonding. The pile yarn may be selected from the group consisting of polyamide, polyolefin, polyester, cotton, acrylic, wool, jute and silk yarns. The pile yarn surface is formed so that it covers between about 5% to about 95% of the upper surface of the decorative fabric.

### DESCRIPTION OF THE DRAWINGS

The invention will be more fully understood from the following detailed description taken in connection with the accompanying drawings, which form a part of this application, and in which:

FIGS. 1A and 1B are stylized pictorial representations of top views of floor covering articles according to the present invention;

FIG. 2A is a side elevational view taken along section lines 2A-2A in FIG. 1A illustrating a first embodiment of the construction of the floor covering article shown in FIG. 1A; and

FIG. 2B is a side elevational view similar to that of FIG. 2A illustrating an alternate embodiment of the present invention.

### DETAILED DESCRIPTION OF THE INVENTION

Throughout the following detailed description, similar reference numerals refer to similar elements in all figures of the drawings.

The floor covering article generally indicated by reference character 10 in accordance with this invention comprises a decorative fabric layer 12 and a decorative pile surface 14 which in combination impart an overall decorative effect when viewed in planar orientation, especially on the floor.

The decorative fabric layer 12 comprises a fabric having a decorative upper surface 12A and a lower surface 12B. The pile yarns 14P forming the decorative pile surface 14 project from the upper surface 12A of the decorative fabric layer 12, and partially cover the upper surface 12A so that a portion of the decorative fabric is clearly visible when the floor covering article is in planar orientation. Means 16 for securing the pile yarns 14P of the decorative pile surface 14 to the decorative fabric layer 12 is provided.

Depending on the type of fabric chosen as the decorative fabric layer 12, the fabric may need to be stabilized in order to increase its stiffness and durability prior to the insertion of the pile yarn 14. If needed, this may be accomplished by applying to the lower surface of the decorative fabric a stabilizing layer 18 formed of an acrylic coating or a laminated thermoplastic film. Application of an acrylic coating may be accomplished by a kiss roll coating operation wherein the coating thickness is controlled by a roll blade or a knife. A thin film of desired thickness is extruded directly onto the underside of the fabric or a previously extruded film using a hot calender roll on the underside of the fabric.

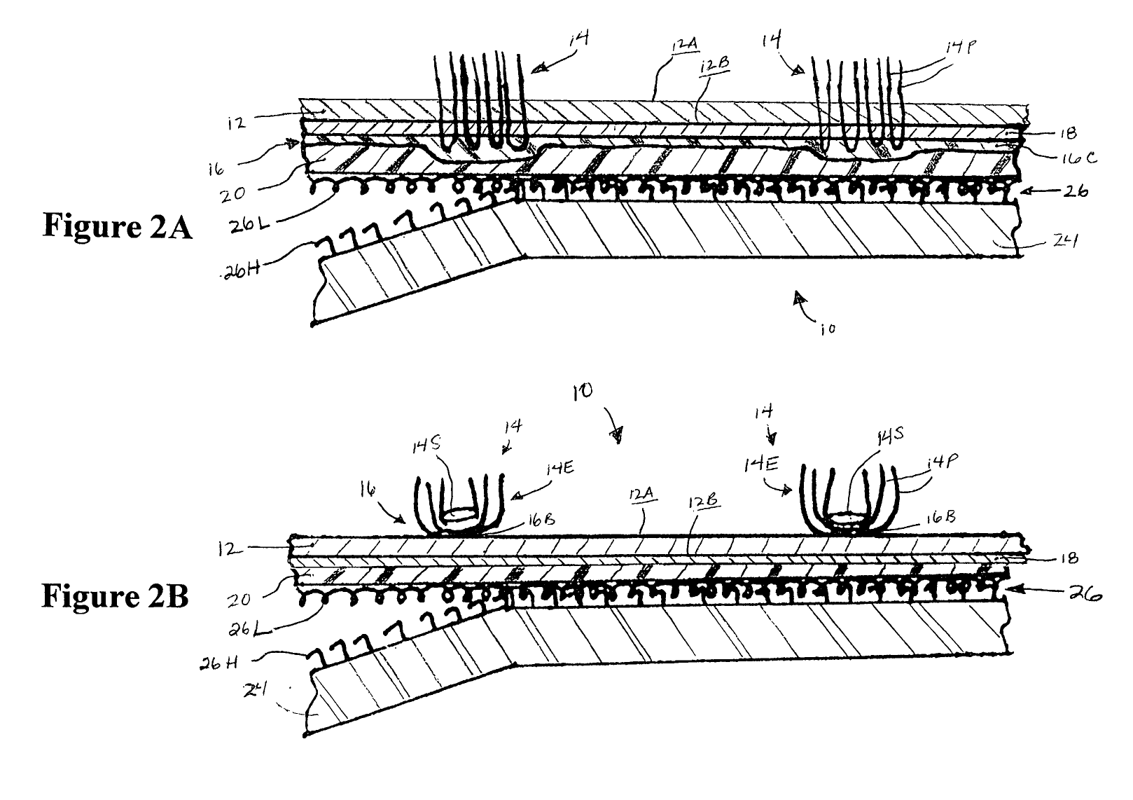

In the construction of the floor covering article 10 shown in FIG. 2A, the pile yarns 14P are tufted into the decorative fabric layer 12. The securing means 16 in this instance comprises a coating 16C disposed on the lower surface 12B of the decorative fabric layer 12 (or the lower surface of the stabilizing layer 18, if provided). The coating 16C may be formed of a latex adhesive, a thermoplastic adhesive, or a hot melt adhesive.

Alternatively, as shown in FIG. 2B,the decorative pile surface 14 is provided in the form of a plurality of elongated pile articles 14E. The term “elongated pile article” as used herein refers to a member formed from an elongated support strand 14S to which a plurality of filament bundles 14P are attached. In this instance the securing means 16 comprises an ultrasonic bond 16B whereby the elongated pile articles 14E are attached to the upper surface 12A of the decorative fabric layer 12. When the elongated pile article 14E is attached to the substrate 10 the filament bundles 14P project upwardly therefrom. The plurality of filament bundles may be cut or loop pile. The filament bundles 14P are attached to the support strand 14S in such a way that, when the elongated pile article 14E is viewed in cross-section, the filament bundles 14P are generally “U”-shaped. The fiber chosen to form the filament bundles of the elongated pile article may be preferably selected from the following: nylon, polyester, polyolefin, and blends thereof. The filament bundles 14P are attached to the support strand 14S either on the inside or the outside of the base of the “U”. Preferably, as is described in U.S. Pat. Nos. 5,472,762 (Edwards et al.) and 5,470,629 (Mokhtar et al.), assigned to the assignee of the present invention, the filament bundles 14P are attached to the support strand 14S using ultrasonic energy. However, the attachment may be effected by adhesive if desired. The strand 14S may be a monofilament structure, a sheath/core structure, a glass-reinforced structure or a twisted multifilament structure, so long as the material of the outer surface of the support strand 14S is compatible with the composition of the filament bundles so that the preferable melt-attachment may be made.

Whatever form of construction is used, when selecting the fabric for the decorative fabric layer 12 or the yarn for use in the decorative pile surface 14, the overall decorative effect must be kept in mind and used as the guide in design choices, such as color, texture, and pattern.

Aside from design choices, the selection of the decorative fabric layer 12 will be based on functional aspects. In general, the yarns suitable for use in a floor covering article 10 are selected from the group consisting of polyamide, polyolefin, polyester, cotton, acrylic, wool, jute and silk. If the floor covering article 10 will be subjected to foot traffic, the yarns used to make the decorative fabric layer 12 should have good tensile properties so that the fabric will be sturdy and wear-resistant. Some floor covering articles will be used mainly for visual decoration, and may not be durable to foot traffic. If a significant portion of the decorative fabric layer 12 will be tufted or subjected to another demanding pile insertion process, the fabric should also be relatively stiff and durable in order to maintain its functional properties. The decorative fabric layer 12 may be a fabric selected from the group consisting of tufted fabric, velour fabric, felt, woven fabric, non-woven fabric, knitted fabric, flocked fabric, stitchbonded fabric, needlepunched fabric and fusion-bonded fabric.

The selection of the pile yarns 14P to form the decorative pile surface 14 will be based on considerations similar to those for the decorative fabric layer 12. The yarns should be selected from the group consisting of polyamide, polyolefin, polyester, cotton, acrylic, wool, jute and silk. The color and texture should be chosen for its coordination with the decorative fabric layer 12. Again, if the floor covering article 10 is intended to withstand frequent foot traffic, the pile yarns 14P should have good tensile properties and the tufts should be designed to maximize wear resistance. Nylon is the preferred pile yarn when frequent foot traffic is a consideration.

As an alternative to tufting and ultrasonic bonding, the decorative pile surface 14 may be formed in the decorative fabric layer 12 by various available means for inserting yarn into a fabric, including needlepunching, fusion-bonding and stitchbonding. Tufting is preferred. Commercially available tufting machines with graphics or “individual control needle” capabilities are ideally suited for use in the present invention, since the decorative pile surface 14 of the invention may take the form of shapes and patterns that are difficult to produce on conventional tufting machines. These include geometric shapes, regularly spaced patterns, stripes, and “free-style” patterns.

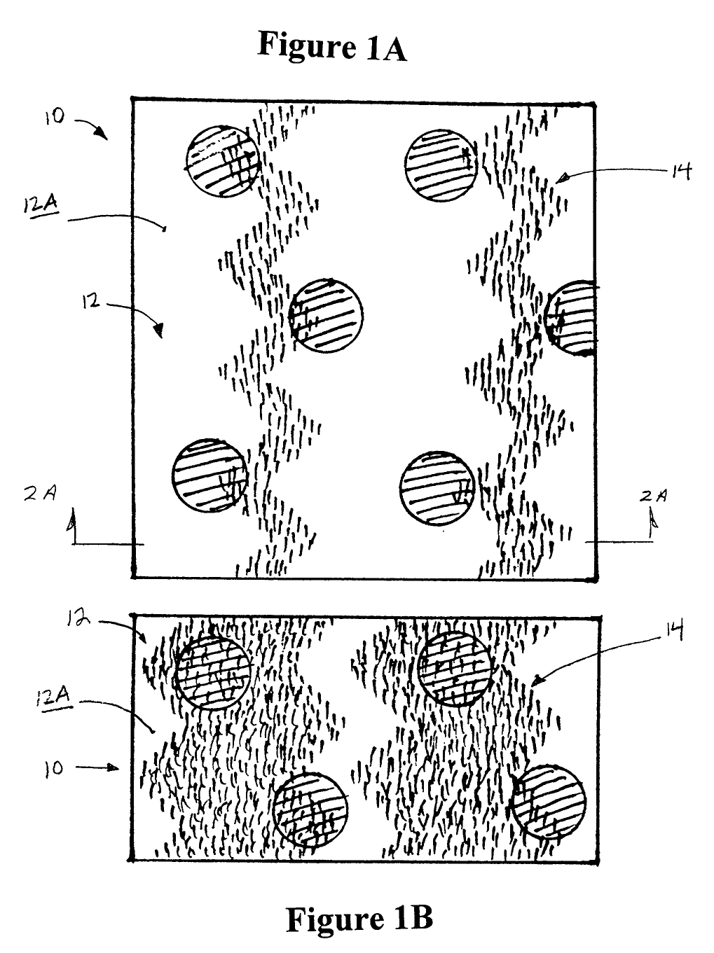

The coverage of the decorative pile surface 14 may vary between about 5% coverage (FIG. 1A), wherein the pile yarns 14P are present merely to accent the decorative fabric layer 12, to about 95% coverage (FIG. 1B), wherein the majority of the upper surface of the decorative fabric layer 12 is covered by pile yarns 14P. It should be understood that, in any given region of the decorative pile surface 14, the pile yarn 14P may have either a sparse stitch density or a dense stitch density, as desired.

Colors and designs may be imparted to the decorative pile surface 14 by dyeing the fiber of which it is made, or by dyeing or printing the decorative fabric layer 12 itself. For example, fibers may be colored or “solution dyed” by adding pigment to the molten polymer prior to extruding the polymer through a spinneret to form filaments. Alternatively, fibers may be pre-dyed by such techniques as “stock-dyeing” (the dyeing of fibers in staple form), skein-dyeing, space-dyeing and package-dyeing. Dyed yarns of different colors may be used to impart to the decorative fabric layer multicolored patterns. Printing involves applying coloring agents onto the fabric which is then treated with heat or chemicals to fix the coloring agents. Printing techniques include, for example, pigment printing, roller printing, screen printing and heat transfer printing.

Different textures and patterns may be imparted to the decorative pile surface 14 by known techniques such as varying the pile height, pile density, pile yarn deniers, and the use of cut and loop pile. Such effects may be achieved using certain available machine capabilities such as scroll attachment, computer graphic capability and individual control needle capability.

Regardless of the yarn density of the decorative pile surface 14 on the upper surface of the decorative fabric layer 12, at least a portion of the decorative fabric layer 12 of the floor covering article 10 is clearly visible when the floor covering article 10 is placed in planar orientation on the floor. By “planar orientation,” it is understood to mean that the floor covering article 10 is placed flat on the floor with the pile yarn surface 14 and upper surface 12A of the decorative fabric layer 12 facing upwards. The portion of the decorative fabric layer 12 that is visible contributes significantly to the overall decorative effect of the floor covering article 10. Whether the design of the decorative fabric layer 12 is visible through the pile surface 14 depends upon the tufting density of the pile surface 14.

As a feature of the overall decorative effect of the floor covering article 10, the decorative fabric layer 12 and the pile yarns 14P of the decorative pile surface 14 are visually distinguishable from each other. The pile yarns 14P are distinguished from the decorative fabric layer 12 preferably by the use of differently colored fibers. Occasionally, the decorative pile surface 14 and the decorative fabric layer 12 will be formed of fibers having the same or similar color, but they will still be visually distinguishable from each other by the use of different depths or saturation levels of the color.

Optionally, the pile yarn surface 14 of the floor covering article 10 may be sheared in order to achieve different decorative effects with the decorative pile surface 14 in the decorative fabric layer 12. The pile yarn 14P may be sheared to varying pile heights using a commercially available carpet shearing machine or fabric-shearing machine. Preferably, the yarn surface is sheared to the surface 12A of the decorative fabric layer 12.

The floor covering article 10 of the invention may include a secondary backing fabric 20 if additional stiffness or body is needed. The secondary backing fabric 20 may be attached in any of the known ways. The secondary backing fabric 20 may be made from fibers known to be useful in carpet backing, including polyamide, polyolefin, polyester, cotton, acrylic, wool and jute. FIG. 1A illustrates the most common method of attaching the secondary backing fabric 20, that is, by attaching it to the adhesive coating 16C while the adhesive is still wet. The floor covering article 10 is then dried and cured.

The secondary backing fabric 20 may be attached to the upper surface of a cushion 24 using a hook-and loop-type mechanical fastener 26. As illustrated, the loop surface 26L may be attached to the secondary backing fabric 20 while the hook surface 26H is attached to the cushion 24. However, it should be understood that these attachments may be reversed. It should be further understood that the secondary backing fabric 20 may be formed having an integral loop or hook surface on the lower surface of the secondary backing fabric 20. The exact forms of the loop and hook surfaces may vary (for example, the loop surface may be a brushed, felt-like fabric) as long as they are releasably attachable to each other, i.e., they easily engage with each other upon contact and can be separated by peeling apart.

### TEST METHODS

Vetterman Drum Test for Wear: Wear tests which closely correlate to floor trafficking were conducted in a Vetterman drum test apparatus, Type KSG, manufactured by Schoenber & Company, Bauber, Federal Republic of Germany, according to International Standards Organization (ISO) document TC38/12/WG 6 N 48. As specified, the drum is lined with the test samples into which is placed a sixteen (16) pound steel ball having fourteen (14) rubber buffers which rolls randomly inside the rotating drum. The test sample is mounted in such a way that the decorative fabric surface stays in contact with the steel ball and the bottom cushion layer stays against the drum. A circular brush within the drum is in light contact with the fabric surface and picks up loose fuzz or fibers which are continuously removed by suction. After five thousand (5,000) and ten thousand (10,000) cycles, the samples are removed and inspected to evaluate texture and appearance retention. Five thousand cycles corresponds to five (5) years of residential use, while ten thousand cycles corresponds to a lifetime of carpet use. Appearance retention is reported on a scale of one through five (1-5) with a rating of five (5) corresponding to a very slight change, a rating of four (4) corresponding to a lightly worn sample, a rating of three (3) corresponding to a moderately worn sample, a rating of two (2) corresponding to a clearly unacceptable wear and a rating of one (1) corresponding to an extremely matted sample. A rating of 2.5 serves as the transition point from acceptable to unacceptable wear.

### EXAMPLES

Example 1 A jacquard woven, yarn dyed nylon fabric with a decorative pattern on its upper surface was used as a decorative fabric layer for a floor covering article. The fabric weighed approximately 20 ounces per square yard. A solution-dyed Antrons Lumena® 1245 denier (18 denier per filament) blue colored nylon 66 yarn from E. I. DuPont de Nemours & Company was used as the pile yarn in a tufting operation. A tufted carpet with 10 stitches per inch stitch density was produced using a Tuftco® ⅛-inch gauge, step-over, cut pile machine with graphics pattern capability. To create a desired surface look, selected needles were taken out from the tufting machine in such a manner that the final carpet alternated 4 inches in width of the tufted decorative pile surface and 4 inches in width of the decorative fabric without any pile yarn. The decorative pile surface covered about 50% of the decorative fabric layer, as determined by visual approximation. The underside of the tufted carpet product was then coated with latex adhesive, to which a secondary polypropylene backing was applied. Lastly, the floor-covering article was allowed to dry. When the carpet was placed in planar orientation on the floor, the decorative fabric was clearly visible.

Example 2 The same jacquard woven decorative fabric used in Example 1 was used as a decorative fabric layer for a floor covering article. A decorative pile surface was imparted with a floral pattern by an individual control needle (ICN) tufting machine made by the Cobble Company in which the tufting needles were controlled by a computer program. A solution dyed Antron® Lumena®, blue colored nylon 66 yarn from E. I. DuPont de Nemours & Company was used as the tufting pile yarn. The floor-covering article with the decorative backing was tufted on a 3/16-inch gauge tufting machine with 10.6 stitches per inch stitch density with a step-over stitching pattern. The tufted decorative pile surface had a floral pattern and covered about 30% of the decorative fabric layer, as determined by visual approximation. This product was then finished in the same way as described in Example 1 with the additional step of final shearing wherein the tufted pile yarn was sheared down to a pile height of about 1 inch. The decorative fabric layer was clearly visible through the floral pattern of the decorative pile surface when the carpet was placed in planar orientation.

Example 3 The decorative fabric layer for a floor covering article was a jacquard woven nylon/wool blend fabric weighing about 27 ounces per square yard, the underside being coated with an acrylic finish as a non-slippage treatment. The treated fabric was then laminated to a brush knit nylon fabric weighing about 2.2 ounces per square yard using a polyurethane foam adhesive. A tufted floor-covering article was prepared in the same way as described in Example 2 using this fabric as the decorative fabric layer.

Example 4 A floor covering article was prepared in the same way as in Example 2, except that a 40 ounces per square yard, flat woven, cotton dhurry with a geometric pattern was used as the decorative fabric layer. The tufted decorative pile surface was created by the ICN tufting machine using the computer program for a small colored dot pattern. The tufted pattern covered about 15% of the decorative dhurry fabric layer, as determined by visual approximation.

Example 5 The same jacquard woven decorative fabric as used in Examples 1 and 2 was used as the decorative fabric layer for a floor-covering article.

A decorative pile surface was tufted into the decorative fabric layer as described in Example 2. Latex adhesive was applied to the underside of the decorative fabric layer and the floor-covering article was allowed to dry. No secondary backing fabric was used. The decorative fabric layer was clearly visible through the floral pattern of the pile yarn surface when the carpet was placed in planar orientation.

Example 6 A 5.0 ounces per square yard, nonwoven, polyester backing having a printed nylon floral flock pattern on its upper surface was used as a decorative fabric layer for a floor covering article. A floor covering article was prepared in the same way as described in Example 2 using a tufted decorative pile surface having a small colored dot pattern, and covering about 15% of the upper surface of the decorative flock patterned backing fabric, as determined by visual approximation. The decorative pile surface served as an accent for the decorative fabric layer so that the upper surface of the decorative fabric layer was the primary feature of the floor-covering article.

Results Samples of the floor covering articles produced in Examples 1 through 6 were evaluated for wear using the Vetterman drum wear test.

Each sample received a wear rating of 4.0 or higher after five-thousand (5,000) cycles, indicating a slightly worn sample, and a wear rating of 3.5 or higher after ten-thousand (10,000) cycles, indicating a lightly worn sample: +P1 Those skilled in the art, having the benefit of the teachings of the present invention as hereinabove set forth, may impart numerous modifications thereto. Such modificiations are to be construed as lying within the contemplation of the present invention, as defined by the appended claims. What is claimed is:

1. A floor covering article comprising:
a) a decorative fabric layer comprising a fabric having an upper and lower surface, wherein the upper surface is decorative,
b) pile yarns forming a decorative pile surface projecting from the upper surface of the fabric, and partially covering the upper surface of the fabric so that a portion of the decorative fabric is clearly visible when the floor covering article is in planar orientation, the overall effect of the decorative fabric and the decorative pile surface being decorative, and
c) means for securing the pile yarns to the decorative fabric layer.

2. The floor covering article of claim 1 wherein the decorative fabric layer comprises a fabric selected from the group consisting of tufted fabric, velour fabric, felt, woven fabric, non-woven fabric, knitted fabric, flocked fabric, stitchbonded fabric, needlepunched fabric and fusion-bonded fabric.

3. The floor covering article of claim 1 wherein the means for securing the pile yarns to the decorative fabric layer comprises a coating on the lower surface of the decorative fabric of latex adhesive, thermoplastic adhesive, or hot melt adhesive.

4. The floor covering article of claim 1 wherein the means for securing the pile yarns to the decorative fabric layer comprises ultrasonic bonding.

5. The floor covering article of claim 1, further comprising a secondary backing fabric attached to the lower surface of the decorative fabric.

6. The floor covering article of claim 1 wherein the decorative fabric and the pile yarns comprise fibers selected from the group consisting of polyamide, polyolefin, polyester, cotton, acrylic, wool, jute and silk.

7. The floor covering article of claim 1 wherein the lower surface of the decorative fabric is attached to a thermoplastic film by thermal bonding.

8. The floor covering article of claim 1, wherein the decorative pile yarn surface is patterned, dyed, or printed.

9. The floor covering article of claim 1 wherein the decorative fabric and the pile yarns are visually distinguishable from each other.

10. A process for making a floor covering article comprising forming a decorative pile surface on a decorative fabric by a method selected from the group consisting of tufting, needlepunching, ultrasonic bonding, fusion-bonding and stitchbonding, wherein the pile yarn is selected from the group consisting of polyamide, polyolefin, polyester, cotton, acrylic, wool, jute and silk, and wherein the decorative pile surface covers between about 5% to about 95% of the upper surface of the decorative fabric.

11. The process of claim 10 wherein prior to forming the decorative pile surface, the decorative fabric is stabilized by applying a stabilizing layer to the lower surface of the decorative fabric, the stabilizing layer being selected from the group consisting of an acrylic coating and laminated film.

12. The process of claim 10 further comprising securing a secondary backing fabric to the lower surface of the decorative fabric by applying an adhesive to the lower surface of the decorative fabric and attaching the secondary backing fabric.

13. The process of claim 12, wherein the lower surface of the secondary backing fabric is a loop surface, releasably attachable to a hook surface member of a hook and loop type mechanical fastener.

14. The process of claim 10 further comprising securing a secondary backing fabric to the lower surface of the decorative fabric by attaching the secondary backing fabric and the decorative fabric with a hook and loop type mechanical fastener.

15. The process of claim 14, wherein the lower surface of the secondary backing fabric is a loop surface, releasably attachable to a hook surface member of a hook and loop type mechanical fastener.

16. The process of claim 10, further comprising shearing the decorative pile surface at the surface of the decorative fabric layer.
